(19) United States
(12) Patent Application Publication
(10) Pub. No.: US 2014/0002347 A1
(43) Pub. Date: Jan. 2, 2014

(54) TOUCH PANEL WITH SAPPHIRE SUBSTRATE AND TOUCH SCREEN

(71) Applicant: GA-LANE CHEN, Santa Clara, CA (US)

(72) Inventor: GA-LANE CHEN, Santa Clara, CA (US)

(21) Appl. No.: 13/675,986

(22) Filed: Nov. 13, 2012

(30) Foreign Application Priority Data
Jun. 27, 2012 (TW) 101123102

(51) Int. Cl. G09G 5/00

(52) U.S. Cl. 345/156

(57) ABSTRACT

A touch panel includes a touch substrate and a touch layer. A touch substrate is made of sapphire. A touch layer includes a plurality of X-axis sensors and a plurality of Y-axis sensors. The X-axis sensors and the Y-axis sensors are positioned on the touch substrate, and an arraying direction of the X-axis sensors is perpendicular to an arraying direction of the Y-axis sensors. The touch panel acquires a touch position by an X-coordinate detected by the X-axis sensors and a Y-coordinate detected by the Y-axis sensors.

### BACKGROUND

1. Technical Field

The present disclosure relates to touch panels, and particularly, to a touch panel with sapphire substrate and a touch screen including the touch panel.

2. Description of Related Art

Touch screens generally include a liquid crystal display and a touch panel covered on the liquid crystal display. The touch panel includes a substrate and a touch layer covered on the substrate. As the substrate generally is made of common glass, the hardness, strength, and weather resistance of the mother glass are often less than satisfactory. As such, touch screen and touch panels cannot be used in harsh environment conditions.

Therefore, it is desirable to provide a touch panel and a touch screen, which can overcome the limitations described.

### BRIEF DESCRIPTION OF THE DRAWINGS

FIG. 1 is a cross-sectional schematic view of a touch screen in accordance with an exemplary embodiment.

FIG. 2 is an isometric view of a touch panel of the touch screen of FIG. 1.

### DETAILED DESCRIPTION

Embodiments of the disclosure will be described with reference to the drawings.

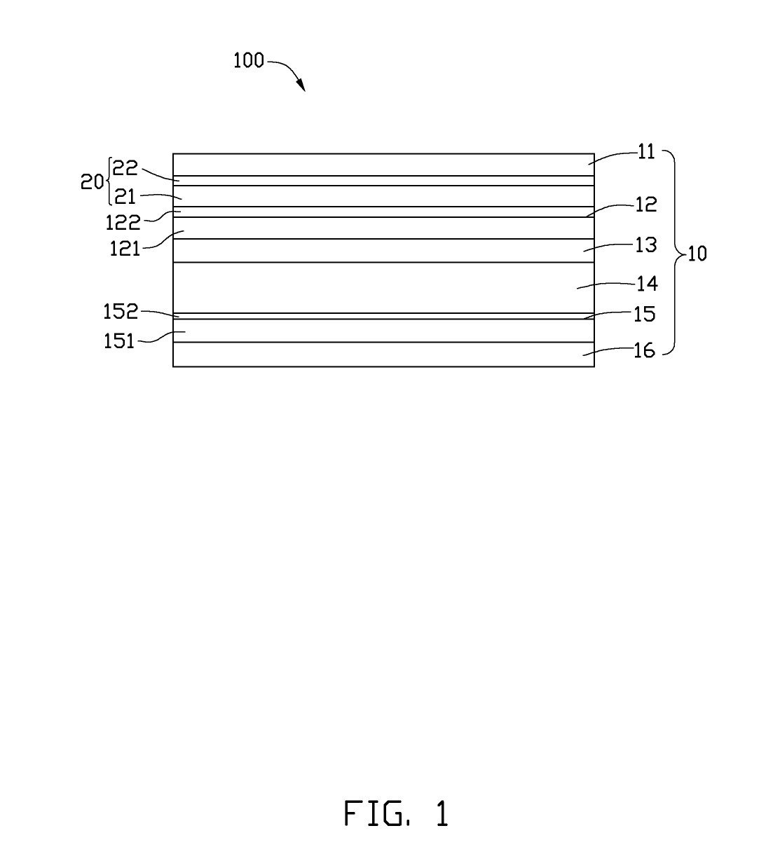

FIG. 1 shows a touch screen 100, according to an exemplary embodiment. The touch screen 100 includes a liquid crystal display 10 and a touch panel 20. The liquid crystal display 10 displays different images using input image signals and according to different touch signals detected by the touch panel 20.

The liquid crystal display 10 includes an upper polarizer 11, a color filter 12, a common electrode layer 13, a liquid crystal layer 14, a pixel electrode layer 15, and a lower polarizer 16. The common electrode layer 13 and the pixel electrode layer 15 are positioned on two sides of the liquid crystal layer 14. The upper polarizer 11 and the lower polarizer 16 are positioned on the outermost of the liquid crystal display 10. The pixel electrode layer 15 is positioned on the lower polarizer 16. The common electrode layer 13 is adjacent to the upper polarizer 11. The color filter 12 is positioned between the upper polarizer 11 and the common electrode layer 13.

The polarities of the upper polarizer 11 and the lower polarizer 16 are opposite. In this embodiment, the upper polarizer 11 transmits P-polarity lights, and the lower polarizer 16 transmits S-polarity lights.

The color filter 12 includes a filter substrate 121 and a color resist layer 122 covered on the filter substrate 121. The filter substrate 121 is made of sapphire. The lights transmitting the color resist layer 122 form colored images.

The common electrode layer 13 is an indium tin oxide (ITO) film deposited on the filter substrate 121 by a chemical vapor deposition. In this embodiment, the color resist layer 122 and the common electrode layer 13 are covered on two opposite sides of the filter substrate 121.

Liquid crystal molecules of the liquid crystal layer 14 are arrayed in an initial alignment direction. The liquid crystal molecules are driven by an electric field generated between the common electrode layer 13 and the pixel electrode layer 15.

The pixel electrode layer 15 includes a pixel substrate 151 and a circuit layer 152 formed on the pixel substrate 151. The pixel substrate 151 is made of sapphire. The circuit layer 152 is made of a transparent material.

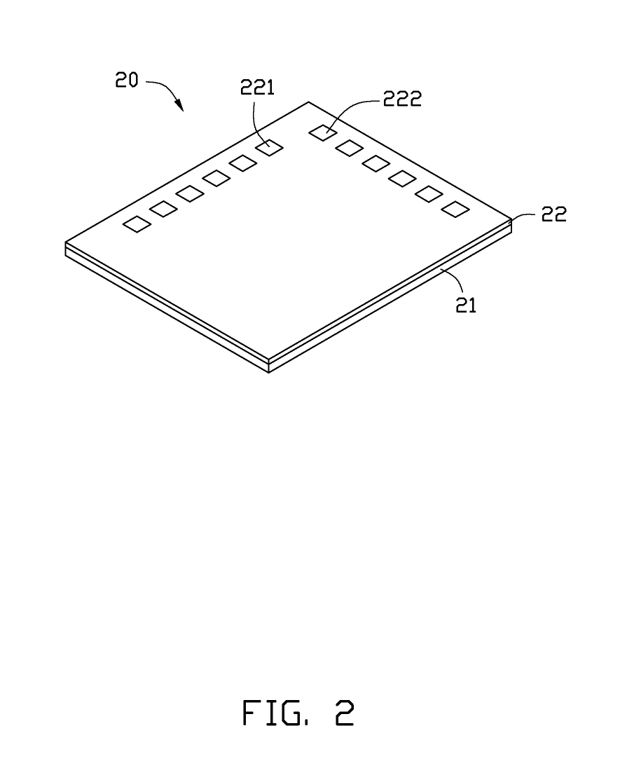

Referring to FIG. 2, the touch panel 20 includes a touch substrate 21 and a touch layer 22 positioned on the touch substrate 21. The touch substrate 21 is made of sapphire. The touch layer 22 includes a number of X-axis sensors 221 and a number of Y-axis sensors 222. The X-axis sensors 221 and the Y-axis sensors 222 are positioned on the touch substrate 21, and an arraying direction of the X-axis sensors 221 is perpendicular to an arraying direction of the Y-axis sensors 222. The touch panel 20 acquires a touch position by an X-coordinate detected by the X-axis sensors 221 and a Y-coordinate detected by the Y-axis sensors 222.

The touch panel 20 is positioned between the upper polarizer 11 and the color filter 12. In the embodiment, the liquid crystal display 10 and the touch panel 20 are electrically connected to a controller (not shown). As the touch panel 20 is positioned in the liquid crystal display 10, therefore the touch panel 20 cannot be damaged by an external force.

In the embodiment, sapphire is a gemstone variety of the mineral corundum, and has a hexagonal crystal structure. The main chemical component of sapphire is aluminum oxide, and the refractive index of the sapphire is from about 1.757 to about 1.760. The growth direction of the sapphire is a-axis (11 2̅0), c-axis (0001), m-axis (10 1̅0). The hardness, strength, and weather resistance of the sapphire is greater than that of the mother glass.

In this embodiment, the process of manufacturing the sapphire is thin film molding. The sapphire ingot is cut into the chip shaped sapphire with a laser blade, and the chip shaped sapphire is cut into the filter substrate 121, the pixel substrate 151, and the touch substrate 21 according to the size of the touch screen 100.

In use, when the touch layer 22 covers the touch substrate 21 detects a touch operation on the upper polarizer 11, the touch panel 20 generates a touch signal to the controller. The controller controls the liquid crystal display 10 displaying different images according to touch signals. As all of the filter substrate 121, the pixel substrate 151, and the touch substrate 21 are made of sapphire, the reliability of the liquid crystal display 10 and the touch panel 20 is increased.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A touch panel, comprising:
a touch substrate made of sapphire; and
a touch layer comprising a plurality of X-axis sensors and a plurality of Y-axis sensors; the X-axis sensors and the Y-axis sensors positioned on the touch substrate, and an arraying direction of the X-axis sensors being perpendicular to an arraying direction of the Y-axis sensors;
wherein the touch panel acquires a touch position by an X-coordinate detected by the X-axis sensors and a Y-coordinate detected by the Y-axis sensors.

2. The touch panel of claim 1, wherein a refractive index of the sapphire is from about 1.757 to about 1.760 and the growth direction of the sapphire is a-axis (11 2̅0), c-axis (0001), m-axis (10 1̅0).

3. A touch screen, comprising:
a liquid crystal display comprising:
an upper polarizer;
a lower polarizer;
a color filter positioned between the upper polarizer and the lower polarizer; and
a liquid crystal layer positioned between the color filter and the lower polarizer;
a touch panel positioned between the upper polarizer and the color filter, the touch panel comprising:
a touch substrate made of sapphire; and
a touch layer comprising a plurality of X-axis sensors and a plurality of Y-axis sensors; the X-axis sensors and the Y-axis sensors positioned on the touch substrate, and an arraying direction of the X-axis sensors being perpendicular to an arraying direction of the Y-axis sensors;
wherein the liquid crystal display displays different images according to different touch signals detected by the touch panel.

4. The touch screen of claim 3, wherein a refractive index of the sapphire is from about 1.757 to about 1.760, and the growth direction of the sapphire is a-axis (11 2̅0), c-axis (0001), m-axis (10 1̅0).

5. The touch screen of claim 3, wherein the color filter comprises a filter substrate and a color resist layer covered on the filter substrate, the color resist layer is positioned between the touch substrate and the filter substrate, and the filter substrate is made of sapphire.

6. The touch screen of claim 3, wherein the liquid crystal display further comprises a common electrode layer and a pixel electrode layer, the common electrode layer is positioned between the color filter and the liquid crystal layer, the pixel electrode layer is positioned between the liquid crystal layer and the lower polarizer.

7. The touch screen of claim 6, wherein the pixel electrode layer comprises a pixel substrate and a circuit layer formed on the pixel substrate, the pixel substrate is made of sapphire.
